(19) United States
(12) Patent Application Publication
(10) Pub. No.: US 2007/0134148 A1
(43) Pub. Date: Jun. 14, 2007

(54) PROCESS AND APPARATUS FOR THE SELECTIVE REMOVAL OF SULFUR-CONTAINING COMPONENTS FROM FEED GAS STREAMS OBTAINED PERIODICALLY

(75) Inventors: Alfred Gubrinski, Erzhausen (DE); Thomas Tork, Frankfurt am Main (DE); Herr Max-Michael Weiss, Oberursel (DE)

Correspondence Address: NORRIS, MCLAUGHLIN & MARCUS, P.A., 875 THIRD AVE, 18TH FLOOR, NEW YORK, NY, 10022, US

(73) Assignee: LURGI AG, Frankfurt/Main (DE)

(21) Appl. No.: 11/563,330

(22) Filed: Nov. 27, 2006

(30) Foreign Application Priority Data
Dec. 8, 2005 (DE) 102005059101.9-43

(51) Int. Cl. B01D 53/48; B01J 8/00

(52) U.S. Cl. 423/242.1; 422/177; 422/178

(57) ABSTRACT

From a gas stream, which in a process for the selective removal of sulfur-containing components is obtained periodically and in fluctuating amounts and/or with fluctuating concentrations of sulfur-containing components, the sulfur-containing components are absorbed by means of a washing agent, the washing agent loaded with the sulfur-containing components subsequently is regenerated, the sulfur-containing components separated during the regeneration are converted to sulfur, and the regenerated washing agent is recirculated to the absorption. To achieve an inflow of the washing agent loaded with sulfur-containing components to the regeneration, which is uniform in terms of time, amount and/or concentration of the sulfur-containing components, it is provided to temporarily store the loaded washing agent upon absorption.

This invention relates to a process and an apparatus for the selective removal of sulfur-containing components, in particular in the form of mercaptans, from feed gas streams containing 50 to 90 vol-% hydrocarbons, which are obtained periodically and in a fluctuating amount and/or fluctuating concentration of sulfur-containing components, from which the sulfur-containing components are absorbed by a countercurrently guided physical washing agent at a pressure of 5 to 80 bar_{abs}, preferably 30 to 50 bar_{abs}, and at a temperature of 0 to 60° C., preferably 20 to 50° C., the clean gas containing the hydrocarbons is discharged for further usage, the physical washing agent loaded with the sulfur-containing components is regenerated, the sulfur-containing components contained in the waste gases obtained during regeneration are converted to sulfur in a downstream stage corresponding to the CLAUS reaction, and the regenerated physical washing agent is recirculated to the absorption.

### BACKGROUND OF THE INVENTION

It is known that the so-called Purisol® process is used for the selective removal of sulfur-containing components from feed gas streams containing hydrocarbons. In an absorption stage, the sulfur-containing components are absorbed by a physical washing agent, in particular N-methylpyrrolidone (NMP), at a pressure of 5 to 80 bar_{abs} and a temperature of 0 to 60° C., and the washing agent loaded with the sulfur-containing components is regenerated by expansion, if necessary also by heating. The waste gases formed thereby, which contain the expelled sulfur-containing components, subsequently are converted to elementary sulfur in a CLAUS plant corresponding to the CLAUS reaction. The regenerated physical washing agent is again charged to the absorption. The disadvantage of physical washing as effected so far and of the related differently designed Purisol® process consists in that a conversion of the sulfur-containing components contained in the waste gas of the regeneration to elementary sulfur in a CLAUS plant is not possible when the feed gas stream is obtained cyclically, i.e. when between the inflow of the feed gas stream and the regeneration thereof a periodically recurring time shift occurs, which possibly can involve a fluctuation of the amount of feed gas and/or a fluctuation of the concentration of the sulfur-containing components.

Periodically obtained feed gas streams, which possibly are subject to fluctuations according to the amount and/or concentration of the sulfur-containing components, can disadvantageously not be processed in a CLAUS plant, but can only be burnt in a flare.

It is the object of the present invention to design the process described above such that a substantially uniform inflow of the physical washing agent substantially uniformly loaded with sulfur-containing components to the regeneration and hence a uniform outflow of the regeneration waste gases containing the sulfur-containing components to a CLAUS plant is ensured.

### SUMMARY OF THE INVENTION

This object is solved in that the washing agent loaded with sulfur-containing components is stored temporarily prior to regeneration, in order to achieve compensation in time, amount and/or concentration between the inflow of the periodically obtained feed gas streams and the regeneration of the washing agent loaded with sulfur-containing components. A uniform inflow of the washing agent uniformly loaded with sulfur-containing components to the regeneration provides for a continuous conversion of the sulfur-containing components contained in the regeneration waste gas to sulfur in a downstream CLAUS plant, as the amount and concentration of the sulfur-containing components in the top product of the regenerator remain the same.

Typically, the absorption of the sulfur-containing components is effected by means of a physical washing agent at a pressure of 15 to 50 bar_{abs}, in particular 15 to 35 bar_{abs}.

Depending on the cycle of the feed gas stream obtained, the washing agent loaded with mercaptans is temporarily stored for a period of 3 to 12 h, preferably 5 to 8 h.

### BRIEF DESCRIPTION OF THE DRAWING

FIG. 1 is a process flow diagram of the process of the invention

### DETAILED DESCRIPTION

A preferred aspect of the process of the invention consists in that in addition the physical washing agent recirculated from the regeneration to the absorption is also stored temporarily. By means of this measure, the circulated amount of physical washing agent can easily be adapted automatically, for instance by cascade flow control, to the alternating amounts of feed gas introduced into the absorber as well as to the concentrations of sulfur-containing components, with the result that the co-absorption under partial load is reduced distinctly and accordingly less hydrocarbons can reach the regeneration together with the loaded washing agent. Another advantage consists in that the amount of regenerated and temporarily stored physical washing agent can be reduced to a hydraulic minimum, when for instance the feed gas stream does not contain any mercaptans. It is furthermore advantageous that the hold-up tank need not be designed for the pressure existing in the absorber, but only to the minimum design pressure. A particular benefit can be seen in that the storage volume of the hold-up tank for the loaded physical washing agent, which is disposed behind the absorber, is reduced considerably, as the circulated amount of physical washing agent can be adapted to the amount of feed gas. This means that the hold-up tank disposed directly behind the absorber and directly before the absorber, respectively, can be reduced in size by up to 37% depending on the cycle of the feed gas stream obtained. About one third of the savings achieved thereby must be used for installing the hold-up tank mounted directly before the absorption. Since the amount of circulated physical washing agent is comparatively lower on average, the volumes of the apparatuses and devices, such as the regenerator, the heat exchangers, the pumps and the receivers thereof, which in a plant for performing the process are provided downstream of the absorption stage, can be designed smaller by up to 37% depending on the cycle time of the feed gas stream obtained.

The temporary storage of the regenerated physical washing agent before charging the same to the absorption is effected at a pressure of 0 to 20 bar_{abs}, preferably 1 to 10 bar_{abs}, for a period of 3 to 12 h, preferably 5 to 8 h.

Useful physical washing agents include in particular N-methylpyrrolidone (NMP), N-formylmorphilane (NFM) and polyglycols.

The apparatus for performing the process of the invention consists of an absorber for expelling a rich gas and for selectively removing sulfur-containing components from a feed stream obtained cyclically and in a fluctuating amount and/or fluctuating concentration of the sulfur-containing components by means of a countercurrently guided washing agent, and of a regenerator connected with the bottom of the absorber containing the loaded washing agent via a heat exchanger for expelling the sulfur-containing components dischargeable into a CLAUS plant and for recovering the washing agent, the bottom of the regenerator being connected with the upper portion of an absorber via a heat exchanger and a hold-up tank being disposed between the bottom of the absorber and downstream before the heat exchanger.

One embodiment of the apparatus described above is a hold-up tank mounted at the connection between the bottom of the regenerator and downstream of the heat exchanger.

The use of the process in accordance with the invention is considered in particular for the selective removal of sulfur-containing components, preferably mercaptans, from gas streams obtained cyclically and in fluctuating amounts and/or fluctuating concentrations of the sulfur-containing components during the removal of CO₂ and H₂S from natural gas by means of a molecular sieve, the cycle being determined by the regeneration time of the molecular sieve.

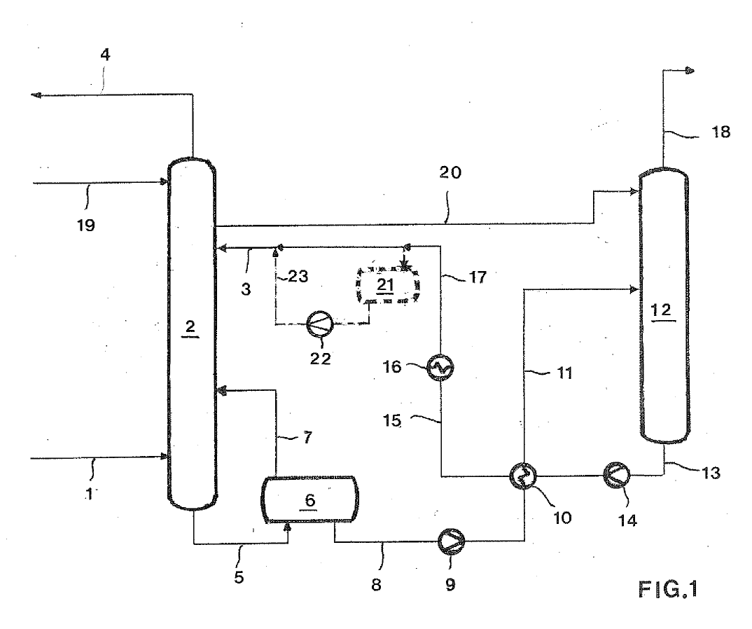

The invention will subsequently be explained in detail by means of two embodiments and with reference to a process flow diagram shown in FIG. 1.

### 1^{st} EMBODIMENT

During the desulfurization of natural gas by using a molecular sieve, a regeneration gas stream of 37,192 Nm³/h is obtained, which contains 64.5% CH₄, 34.2% N₂, 0.2% C₂ to C₈ hydrocarbons, 0.64% mercaptans, traces of COS and H₂S, rest water, and which via conduit (1) is introduced into the lower part of an absorber tray column (2), in which the regeneration gas stream is washed countercurrently at a pressure of 24.9 bar_{abs} and a temperature of 45° C. by means of NMP charged into the upper part of the absorber tray column (2) via conduit (3). From the top of the absorber tray column (2), a clean gas stream of 36,648 Nm³/h, containing 64.8% CH₄, 34.6% N₂, 0.17% C₂ to C₈ hydrocarbons, 9 ppm mercaptans, 6 ppm COS, 3 ppm H₂S, rest water, is discharged through conduit (4) for further usage. From the bottom of the absorber tray column (2),a liquid stream loaded with mercaptans of 89,582 kg/h, which contains 72.6% NMP, 25.4% water, 0.92% mercaptans, 0.9% CH₄ and 0.12% N₂, is withdrawn via conduit (5) at a pressure of 25 bar_{abs} and a temperature of 48° C. and introduced into a hold-up tank (6), in which a pressure compensation with the absorber tray column (2) is effected via conduit (7). Via conduit (8), a liquid stream is charged continuously by means of a pump (9) via a heat exchanger (10) and then via conduit (11) to a regenerator tray column (12). By means of the pump (9) and the heat exchanger (10), the pressure of the liquid stream is increased to 29 bar_{abs} and the temperature is raised to 150° C. From the bottom of the regenerator tray column (12), a liquid stream of 88,388 kg/h, which consists of 75.1% NMP and 24.9% H₂O, is discharged via conduit (13) and delivered via the pump (14) through the heat exchanger (10), via the conduit (15), the heat exchanger (16), the conduit (17) and the conduit (3) into the upper portion of the absorber tray column (2). As a result of the heat exchange, the temperature of the liquid stream is decreased to 45° C. At the top of the regenerator tray column (12), a waste gas stream of 664 Nm³/h, which contains 36% CH₄, 54% mercaptans, 4.3% water, 4.5% N₂ and 1.2% hydrocarbons, is discharged and delivered to a CLAUS plant via conduit (18). At the top of the absorber tray column (2), 252 kg/h of washing water are charged via conduit (19), and a partial stream removed therefrom is charged to the top of the regenerator tray column (12) via conduit (20).

### 2^{nd} EMBODIMENT

A regeneration gas stream of 37,192 Nm³/h produced during the desulfurization of natural gas by means of a molecular sieve contains 64.5% CH₄, 34.1% N₂, 0.2% C₂ to C₈ hydrocarbons, 0.64% mercaptans, traces of H₂S and COS, rest water, and is supplied to the lower part of the absorber tray column (2) via conduit (1). In the absorber tray column (2), the regeneration gas stream is washed countercurrently with NMP charged via conduit (3) at a pressure of 25 bar_{abs} and a temperature of 45° C. From the top of the absorber tray column (2), 36,785 Nm³/h of clean gas, composed of 64.9% CH₄, 34.5% N₂, 0.2% C₂ to C₈ hydrocarbons, 166 ppm mercaptans, 4 ppm H₂S, 7 ppm COS, rest water, is removed via conduit (4) and discharged for further usage. The liquid stream of 48,425 kg/h loaded with mercaptans, which is withdrawn from the bottom of the absorber tray column (2), contains 71.3% NMP, 26% water, 0.92% CH₄, 0.12% N₂ and flows into the hold-up tank (6) via conduit (5), in which tank a pressure of 25 bar_{abs} and a temperature of 50° C. exist. As pressure compensation with the absorber tray column (2) is effected from the hold-up tank (6) via conduit (7), approximately the same pressure and temperature conditions as in the absorber tray column (2) are ensured in the hold-up tank (6). Via the conduit (8), the pump (9), the heat exchanger (10) and the conduit (11), the liquid stream, whose pressure and temperature are increased to 29 bar_{abs} and 150° C., respectively, by the pump (9) and the heat exchanger (10), respectively, is supplied continuously from the hold-up tank (6) to the middle portion of the regenerator tray column (12). Via conduit (13) and the pump (14), a liquid stream of 47,352 kg/h, containing 75.1% NMP and 24.9% water, is withdrawn from the bottom of the regenerator tray column (12), passed through the heat exchanger (10), then via conduit (15) through the heat exchanger (16) by decreasing the temperature to 45° C., and is then charged via conduit (17)—indicated by a broken line—to another hold-up tank (20) and from the same fed via conduit (22) into conduit (3) by means of the pump (21). Via conduit (3), regenerated liquid containing NMP is sprayed into the upper part of the absorber tray column (2). At the top of the regenerator tray column (12), a waste gas stream of 431 Nm³/h, containing 30% CH₄, 61% mercaptans, 4% water, 3.9% N₂ and 1% C₂ to C₄ hydrocarbons, is withdrawn via conduit (18) and supplied to a CLAUS plant. At the top of the absorber tray column (2) 252 kg/h of water are supplied via conduit (19), part of the water being branched off and charged to the top of the regenerator tray column (12) via conduit (20).

1. A process for the selective removal of sulfur-containing components from feed gas streams containing 50 to 90 vol-% hydrocarbons, which are obtained periodically and in fluctuating amounts of sulfur-containing components, fluctuating concentrations of sulfur-containing components or in both fluctuating amounts and fluctuating concentrations of sulfur-containing components, from which the sulfur-containing components are absorbed by a countercurrently guided physical washing agent at a pressure of 5 to 80 bar_{abs} and at a temperature of 0 to 60° C., and the clean gas containing the hydrocarbons is discharged for further usage, the physical washing agent loaded with sulfur-containing components is regenerated, the sulfur-containing components contained in the waste gases obtained during regeneration are converted to sulfur in a downstream stage corresponding to the CLAUS reaction, and the regenerated physical washing agent is recirculated to the absorption, wherein the physical washing agent loaded with sulfur-containing components is stored temporarily prior to regeneration.

2. The process as claimed in claim 1, wherein the absorption of the sulfur-containing components is effected at a pressure of 15 to 50 bar_{abs}.

3. The process as claimed in claim 1, wherein the washing agent loaded with mercaptans is stored temporarily for a period of 3 to 12 h.

4. The process as claimed in claim 1, wherein the regenerated washing agent is stored temporarily before being charged to the absorption.

5. The process as claimed in claim 4, wherein the regenerated washing agent is stored temporarily for a period of 3 to 12 h at a pressure of 0 to 20 bar_{abs}.

6. An apparatus for performing the process of claim 1, comprised of an absorber (2) for expelling a rich gas and for selectively removing sulfur-containing components from feed streams obtained periodically and in fluctuating amounts fluctuating concentrations, or both, by means of a countercurrently guided physical washing agent, and of a regenerator (12), which is connected with the bottom of the absorber containing the loaded washing agent via a heat exchanger (10), for expelling the sulfur-containing components dischargeable into a CLAUS plant and for recovering the washing agent, the bottom of the regenerator being connected with the upper portion of the absorber via a heat exchanger (10), wherein a hold-up tank (6) is disposed between the bottom of the absorber (2) and downstream before the heat exchanger (10).

7. The apparatus as claimed in claim 6, further comprising a hold-up tank (21) disposed in the connection between the bottom of the regenerator (12) and the upper portion of the absorber (2) downstream of a heat exchanger (10).

8. A method for the selective removal of sulfur-containing components from gas streams obtained periodically and in a fluctuating amount and/or fluctuating concentration of the sulfur-containing components during the removal of CO₂ and H₂S from natural gas by means of a molecular sieve, which comprises removing said sulfur-containing components from said gas streams by the process of claim 1.

9. The process of claim 1, wherein said sulfur-containing components are mercaptans.

10. The process of claim 1, wherein said pressure is 30 to 50 bar_{abs}, and said temperature is 20 to 50° C.

11. The process of claim 2, wherein said pressure is 15 to 35 bar_{abs}.

12. The process of claim 3, wherein the washing agent loaded with mercaptans is stored temporarily for a period of preferably 5 to 8 h.

13. The process of claim 5, wherein said regenerated washing agent is stored at a pressure of 1 to 10 bar_{abs}.

14. The process of claim 5, wherein said regenerated washing agent is stored for a period of 5 to 8 h.

15. The method of claim 8, wherein said sulfur-containing components are mercaptans.
